(19) United States
(12) Patent Application Publication
(10) Pub. No.: US 2016/0291173 A1
(43) Pub. Date: Oct. 6, 2016

(54) STRUCTURE HAVING METAL HALIDE LAYER, RADIATION DETECTION ELEMENT, RADIATION DETECTOR, AND METHOD FOR MANUFACTURING THE STRUCTURE

(71) Applicant: CANON KABUSHIKI KAISHA, Tokyo (JP)

(72) Inventors: Ryoko Ueyama, Yokohama-shi (JP); Toru Den, Tokyo (JP); Tatsuya Saito, Kawasaki-shi (JP); Tatsuya Iwasaki, Machida-shi (JP)

(73) Assignees: CANON KABUSHIKI KAISHA, Tokyo (JP); CANON KABUSHIKI KAISHA, Tokyo (JP)

(21) Appl. No.: 15/100,964

(22) PCT Filed: Dec. 1, 2014
(86) PCT No.: PCT/JP2014/082349

§ 371 Date: Jun. 1, 2016

(30) Foreign Application Priority Data
Dec. 5, 2013 (JP) 2013-252550
Nov. 21, 2014 (JP) 2014-236992

(51) Int. Cl. G01T 1/202; G21K 4/00

(52) U.S. Cl. CPC G01T 1/2023; G21K 4/00; G21K 2004/04

(57) ABSTRACT

A radiation detection element has a detection layer 52 containing metal halide and a pair of electrodes 51 and 53 disposed on the detection layer 52 containg metal halide. At least one of the pair of electrodes has a surface 56 containing graphite and the surface 56 containing graphite and the detection layer 52 are in contact with each other.

### TECHNICAL FIELD

The present invention relates to a structure having a metal halide layer, a radiation detection element, a radiation detector, and a method for manufacturing the structure.

### BACKGROUND ART

In radiation detectors for use in the medical field, radiation detectors having a radiation detection element in which metal halide, such as lead iodide (PbI₂), mercury iodide (HgI₂), or bismuth iodide (BiI₃), is used as a detection layer have been researched. The detection layer containing metal halide is known to be formed by a bulk or a thin film. However, when a thin film is used, denseness is insufficient. Therefore, it is known that a short circuit sometimes occurs due to a defect between electrodes disposed on both sides of the detection layer.

To address the problem, PTL I describes using a conductive film containing one element selected from the group consisting of Se, Te, HgS, CdS, AgI, Ca, B₂O₃, RbC₈, Co₂N, Cr₂N, CoTa₂N₂, FeTa₂N₂, TaN, V₂N, Ni, Ge, αSn, CdSe, InSb, AlSb, GaSb, PbTe, AgBr, CdTe, HgTe, PbS, γCa, Eu, γSr, βTh, βTl, SnO₂, TiN, ZrN, HfN, VN, and CrN and having lattice mismatch with a detection layer of less than 20% as electrodes to thereby control the orientation of the detection layer to reduce defects of the detection layer, and suppress a short circuit.

### CITATION LIST

### Patent Literature

PTL 1 Japanese Patent Laid-Open No. 2004-191102 (corresponding to U.S. Patent Application Publication No. 2004/0113087)

### SUMMARY OF INVENTION

### Technical Problem

The present invention provides a method for a structure having a metal halide layer capable of controlling the orientation of the metal halide layer using A conductive film different from the conductive film described in PTL 1. Moreover, the present invention also provides a structure which can be manufactured by the manufacturing method and a radiation detection element and a radiation detector having the structure. The radiation detection element and the radiation detector having the structure have a pair of electrodes and a detection layer with denseness equal to or higher than the level in which a short circuit does not occur between the electrodes.

### Solution to Problem

A structure has a metal halide layer and a substrate having a surface containing graphite, in which the metal halide layer and the surface containing graphite are in contact with each other.

Further features of the present invention will become apparent from the following description of exemplary embodiments with reference to the attached drawings.

### BRIEF DESCRIPTION OF DRAWINGS

FIG. 1 is an optical microscope image of a detection layer according to Example 1.

FIGS. 2A and 2B are optical microscope images of a BiI₃ detection layer according to Example 2.

FIG. 3 is an optical microscope image of a BiI₃ detection layer according to a comparative example.

FIGS. 4A to 4D are growth models on graphite of a BiI₃ detection layer according to this embodiment.

FIGS. 5A to 5C are schematic views of a radiation detection element according to this embodiment.

FIG. 5D is a schematic view of a structure according to this embodiment

FIG. 6 is X-ray response evaluation results of a radiation detection element according to Example 3.

### DESCRIPTION OF EMBODIMENT

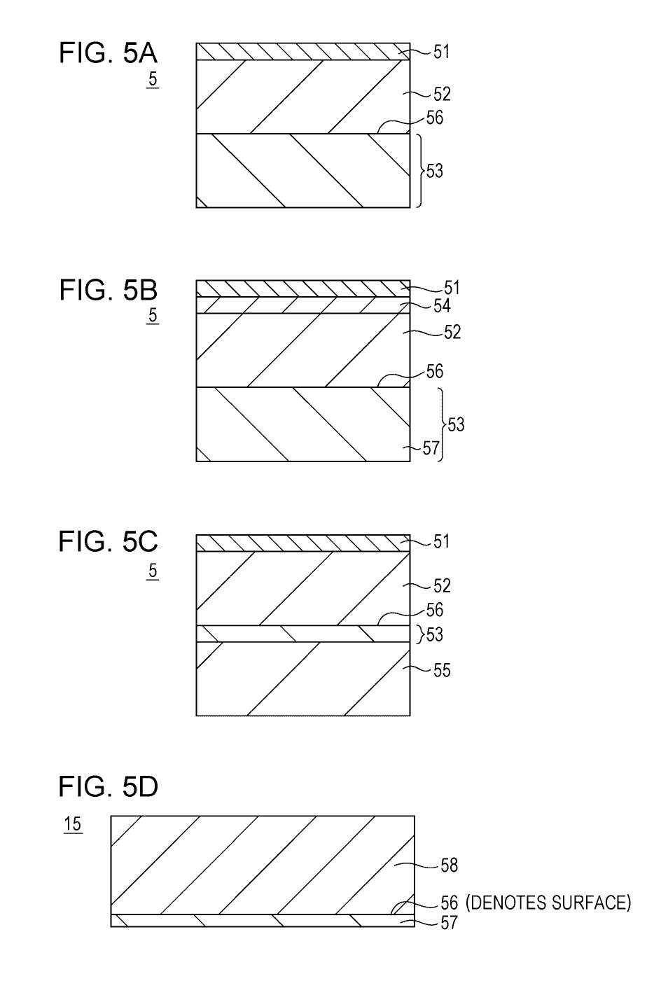

Hereinafter, an embodiment for carrying out the present invention is described with reference to FIGS. 5A to 5D. A structure according to this embodiment is illustrated in FIG. 5D. A structure 15 according to this embodiment has a metal halide layer 58 and a substrate 57 having a surface 56 containing graphite, in which the metal halide layer 58 and the surface 56 containing graphite are in contact with each other. Such a structure can be used as a radiation detection element, for example. The following description is given taking a case where the structure according to this embodiment is utilized as a radiation detection element as an example. FIGS. 5A to 5C are schematic views of a radiation detection element 5 utilizing the above-described structure.

The radiation detection element 5 has a detection layer 52 containing metal halide and a pair of electrodes 51 and 53 disposed on the metal halide. At least one of the pair of electrodes has the surface 56 containing graphite and the surface 56 containing graphite and the detection layer 52 are in contact with each other. In the present invention and this specification, graphite includes graphene.

The shape of the metal halide may be any one of a bulk-like crystal, a polycrystal, or a film (layer) shape. The metal halide is suitably bismuth iodide (BiI₃), lead iodide (PbI₂), or mercury iodide (HgI₂) which is heavy metal halide from the viewpoint of radiation absorption. From the viewpoint of environmental consideration, bismuth iodide is more suitable. It is a matter of course that a material in which Bi is partially replaced by Pb, Sb, or the like or a mixed crystal in which I is partially replaced by another halogen, such as Br, may be acceptable.

The electrode 53 having the surface 56 containing graphite is not particularly limited insofar as the electrode has the surface 56 containing graphite. As illustrated in FIG. 5A, the entire electrode may contain graphite or, as illustrate in FIG. 5B, the electrode 53 may have a structure in which a graphite film is formed on the substrate 57 containing a conductive material. The surface 56 containing graphite is almost parallel to the c plane of the graphite crystal.

As a material of the electrode with which bismuth iodide which is one metal halide is in contact, Pd, Si, and the like have been known. However, the present inventors of the present invention have newly proved that when graphite is used as the material of the electrode with which bismuth iodide is in contact, the orientation of bismuth iodide becomes the c-axis orientation and the denseness becomes higher than that in the case where Pd or Si is used as the material of the electrode. The c-axis orientation refers to the orientation in which the c-axis of the crystal is vertical to the electrode. When X-ray crystal structure analysis of the c-axis oriented metal halide is performed, the peaks appear on (003), (006), (009), and (012).

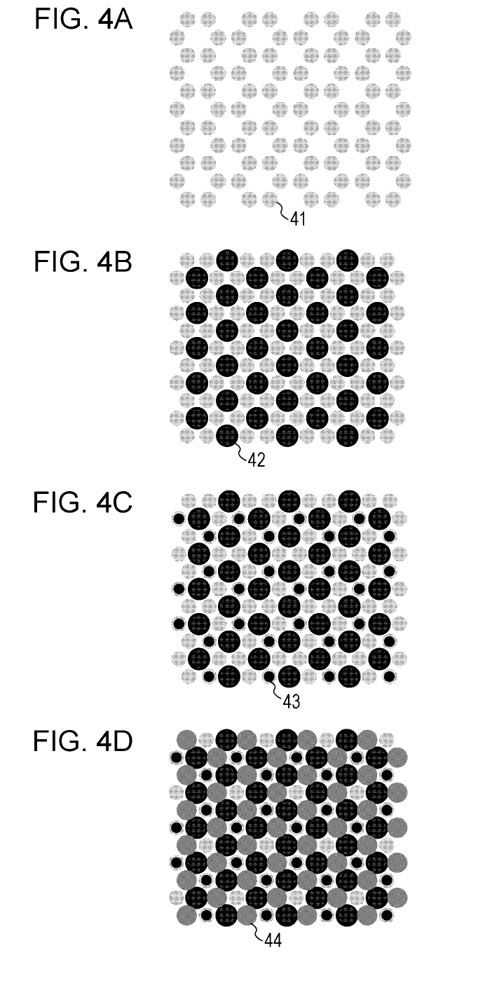

Graphite has a structure in which layers having a two-dimensional network in which carbon atoms having a bond length of 0.142 nm are arranged in the shape of a honyecomb-shaped hexagonal lattice are stacked while shifting in the c-axis direction (however, single layer graphene does not have the stacking structure). The present inventors of the present invention have found that metal halide favorably epitaxially grows or grows in a manner similar to the epitaxial growth on the two-dimensional network. FIGS. 4A to 4D illustrates a model which estimates the state. However, in FIGS. 4A to 4D, BiI₃ is used as metal halide which is the detection layer. FIG. 4A illustrates the arrangement of carbon atoms (c) 41 on the top surface of the graphite. On the carbon atoms, first iodine atoms 42 as a halide element are disposed in such a manner as to be located at the center of the honeycomb formed by the graphite (FIG. 4B). Next, bismuth (Bi) 43 is disposed at specific positions each bonded to three first iodine atoms (1) 42 (FIG. 4C). Furthermore, second iodine atoms (I) 44 are disposed on the layer of the bismuth 43 in a manner opposite to the manner illustrated in FIG. 4B (FIG. 4D). When BiI₃ grows on the graphite in this manner, the lattice mismatch can be reduced to only less than 2%. Therefore, BiI₃ can epitaxially grow on the graphite. Since other metal halide systems have a similar structure, the same effect can be expected. In FIGS. 4A to 4D, since the graphite is graphite (single crystalline graphite) in which the a-b orientation is uniform, the a-b orientation of metal halide is also uniform.

When metal halide is formed into a film on graphite (polycrystalline graphite) in which the a-b orientation is not uniform, the a-b orientation of the metal halide formed into a film is also not uniform but the c-axis direction is uniform.

The surface containing graphite more suitably contains graphene or single crystalline graphite. When the surface containing graphite contains graphene or single crystalline graphene, the a-b orientation of the metal halide is uniform as illustrated in FIGS. 4A to 4D. Therefore, the denseness of the detection layer further improves. In the present invention and this specification, graphene has 1 to 5 layers having the two-dimensional network described above. Any graphene may be acceptable and, particularly, graphene grown on a SiC substrate 55 is more suitable because the graphene has a structure similar to the structure of a single crystal. In the case of graphite on the SiC substrate 55, even when the graphite has six or more layers having the two-dimensional network described above, the a-b orientation of metal halide is uniform. Therefore, when the surface containing graphite is a surface of the graphite formed on the SiC substrate, the denseness of the detection layer further improves. The number of layers of the graphite in this case may be one layer or tens of layers.

When using bismuth iodide as the metal halide, the detection layer 52 in contact with the surface 56 containing graphite can be manufactured by forming a bismuth iodide film having a thickness of about 50 μm to 100 μm on the surface 56 containing graphite of the substrate serving as the electrode 53. A film forming method is not particularly limited and, for example, a vapor deposition method, a vapor phase transport method, and the like can be used. Specifically, a heater is disposed on an upper portion (substrate side) and a lower portion. (source (material) side), and controls a film forming rate to a desired film forming rate. The lower heater is disposed around a quartz container in which a bismuth iodide material is placed, and then a substrate holder containing quartz in which the substrate is set with the surface containing graphite facing down is disposed immediately on the quartz container. Then, the upper heater is disposed through a fixture containing a material having good heat conduction, and then the temperature of the upper and lower heaters is set to an appropriate temperature. Then, a bismuth iodide film can be formed on the surface containing graphite of the substrate. At this time, it is desirable to use, for bismuth iodide serving as the raw material, one in which the impurity content is reduced by filling a (quartz tube with BiI₃ (Purity of 99.99%) powder, and then purifying the same by sublimation in an electric furnace in which the temperature gradient is controlled. The purifying method of the BiI₃ raw material and the BiI₃ film vapor deposition method are not limited to the methods described above and other methods may be used. A BiI₃ crystal similar to a thick single crystal can also be formed into a film by forming a film over a long period of time. When using metal halide other than BiI₃ as the detection layer, the detection layer can be manufactured in the same manner. When a vapor deposition method or a vapor phase transport method is used, metal halide to be formed into A film tends to have a small crystal size in the early stage of the film formation and the crystal size tends to become larger as the film formation proceeds. Therefore, in a region close to the surface 56 containing graphite of the substrate and in a region distant from the surface 56 containing graphite in the thickness direction of the detection layer, the crystal size is larger in a region in which a distance from the surface 56 containing graphite is larger.

Since the substrate when manufacturing the detection layer contains graphite having conductivity, the substrate can function as an electrode of a radiation detection element. Hereinafter, the electrode having the surface containing graphite is sometimes referred to as a first electrode.

In order to cause the structure to function as a radiation detection element, it is necessary to dispose one or more pairs of electrodes on the detection layer. More specifically, it is necessary to dispose not only a first electrode but a second electrode 51 which forms a pair with the first electrode on the detection layer. The second electrode may be disposed directly on the detection layer or may be disposed through a layer other than the electrode, e.g., a layer referred to as a blocking layer 54, for example (FIG. 5B). The blocking layer is provided for the purpose of reducing a dark current and a semiconductor whose band gap is wider than that of the detection layer is used as the blocking layer 54 in many cases. It has been found that when the electrode is disposed directly on the detection layer, it is suitable that a surface containing Au contacts the detection layer. However, a surface containing a material other than Au may be in contact with the detection laver. The second electrode may also have a surface containing graphite and the surface may be in contact with the detection layer. The second electrode is suitably disposed on a surface facing the contact surface with the surface containing graphite of the detection layer.

By electrically connecting the electrodes of the radiation detection element thus formed and a signal processing unit, a radiation detector can be manufactured. Since the first electrode or the second electrode functions as a pixel electrode, two or more of the electrodes are formed. The signal processing unit causes a storage capacitor connected to each pixel electrode to store a signal charge, and then successively reads the signal charge in each pixel.

### EXAMPLE 1

Example 1 of the present invention has a pair of electrodes and a detection layer containing a BiI₃ film. Among the pair of electrodes, one electrode (first electrode) is an electrode containing graphite and the other electrode (second electrode) is an electrode containing Au,

First, 1 g of BiI₃ purified by sublimation is put into a quartz container and a graphite substrate is set to a substrate holder as described above. The set was held for 10 hours in a state where the preset temperature of a lower heater for sublimation of the raw materials was set to 230° C. and the preset temperature of an upper heater for heating a substrate was set to 120° C., and then BiI₃ was formed into a film having a thickness of about 50 μm on the graphite substrate.

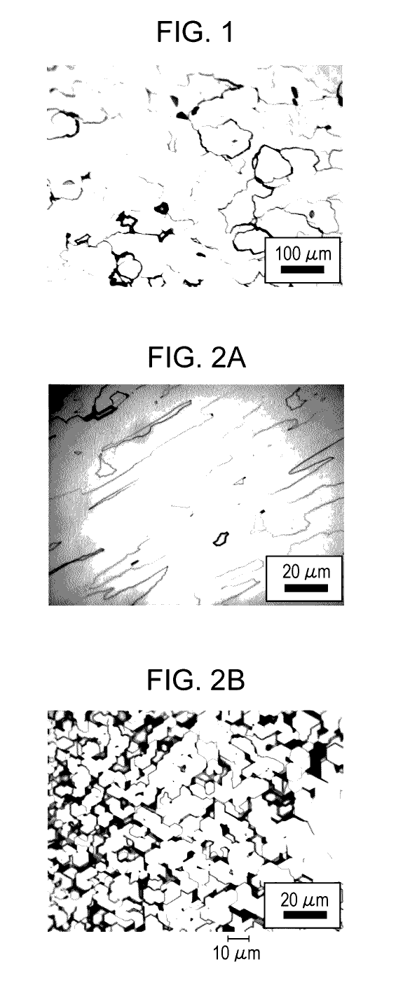

After forming BiI₃ into a film, the surface shape of the film was observed under an optical microscope. Then, a dense film which was c-axis oriented as illustrated in FIG. 1 was confirmed. It is imagined that, by forming metal halide into a film on the surface containing graphite, a metal halide film with high denseness can be formed. Thus, a BiI₃ detection layer with high denseness was able to be formed. An Au electrode was disposed on the BiI₃ detection layer, and then X-rays were emitted thereto while applying a voltage between the electrodes to evaluate the X-ray response characteristics. Then, a short circuit did not occur between the electrodes and a signal from a radiation detection element was able to be detected.

### EXAMPLE 2

This example is the same as Example 1, except that a first electrode is an electrode containing graphene.

BiI₃ was formed into a film having a thickness of about 50 μm on a graphene substrate using the same method as that of Example 1. When the surface shape of the film was observed under an optical microscope, a dense film which was c-axis oriented as illustrated in FIG. 2A was confirmed. Furthermore, as illustrated in FIG. 2B, it was confirmed that the BiI₃ film on the graphene substrate was a dense film in which the a-b orientation was uniform, i.e., an epitaxially-grown BiI₃ film was formed on the surface containing graphene. Thus, by forming metal halide into a film on the surface containing graphene, a detection layer containing a metal halide film having high denseness was able to be formed. An Au electrode was disposed on the detection layer, and then X-rays are emitted thereto while applying a voltage between the electrodes to evaluate the X-ray response characteristics. Then, a short circuit did not occur between the electrodes and a signal from a radiation detection element was able to be detected.

### EXAMPLE 3

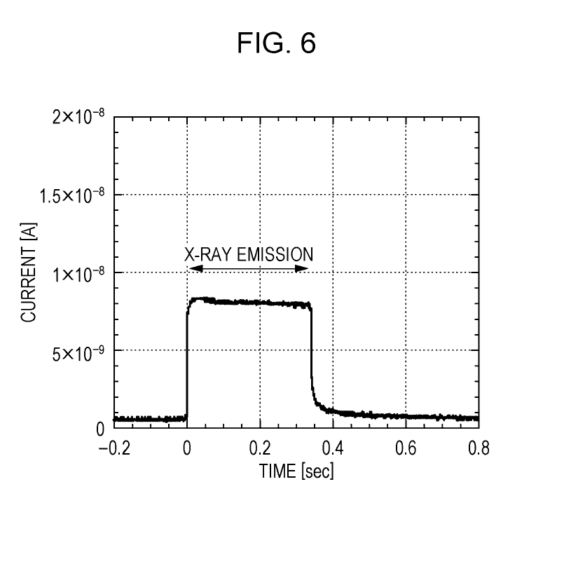

This example describes the evaluation results of the X-ray response characteristics of the radiation detection element of Example 2. As the radiation detection element, one in which a BiI₃ film having a film thickness of 46 μm was formed on a graphene electrode is used. Onto the BiI₃ film, a conductive graphite tape (2×2.5 mm²) is stuck, and then an upper electrode is disposed thereon. FIG. 6 shows the measurement results of the X-ray response characteristics when using the above-described radiation detection element. FIG. 6 shows the X-ray response characteristics in the case where X-rays entered from the BiI₃ film side and a positive bias voltage was applied and shows the relationship of the detection sensitivity of X-rays and a dark current in X-ray emission and in no X-ray emission. The measurement is performed by emitting X-rays at an irradiation rate of 12.6 [R/sec] from an X-ray tube having a tube voltage of 60 kV and a tube current of 1 mA. The rise of the X-ray sensitivity in X-ray emission is 4.8 nA and a dark current is 365 pA, so that a rectangular X-ray response waveform is formed. The resistivity is 3×10¹⁰ [Ωcm]. More specifically, a short circuit did not occur between the electrodes disposed on both sides of the detection layer and a signal from the radiation detection element was able to be detected.

### Comparative Example

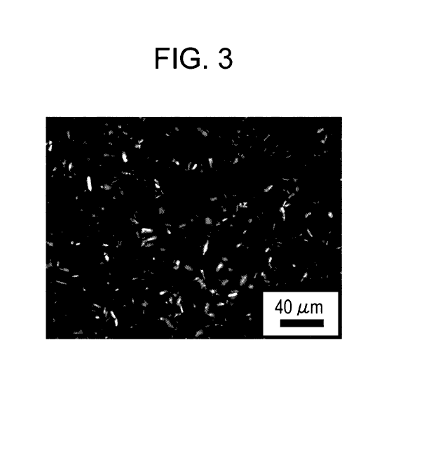

As a comparative example, BiI₃ was formed into a film on an Si electrode by the same method as that of Example 1 and Example 2. At this time, the BiI₃ film of the detection layer was randomly oriented as illustrated in FIG. 3 and the gaps and the irregularities of the surface were larger than those of the BiI₃ films of Examples 1 and 2, so that the denseness was low. When Au electrodes were disposed on the detection layer and a voltage was applied between the electrodes, a short circuit occurred between the electrodes due to a defect in the detection layer. As a result, the X-ray response characteristics were not able to be evaluated and also a signal from the radiation detection element was not able to be detected.

The embodiment above is described taking the case where a structure having a metal halide layer and a substrate having a surface containing graphite is used for a radiation detection element as an example, but a dense metal halide layer can be used as appropriate if necessary.

The present invention can provide a radiation detection element in which a conductive film different from the conductive film described in PTL 1 is used as electrodes and which has a detection layer having denseness equal to or higher than the level in which a short circuit does not occur between the electrodes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-252550, filed Dec. 5, 2013, and No. 2014-236992, filed Nov. 21, 2014, which are hereby incorporated by reference herein in their entirety.

1. A structure comprising:
a metal halide layer; and
an electrode having a surface containing graphite,
wherein the metal halide layer and the surface containing graphite are in contact with each other.

2. The structure according to claim 1, wherein the metal halide layer is a bismuth iodide layer.

3. The structure according to claim 1, wherein, in the metal halide layer, the metal halide is c-axis oriented.

4. The structure according to claim 1, wherein the metal halide layer is a layer formed by forming metal halide into a film on a graphite layer.

5. The structure according to claim 1, wherein the surface containing graphite contains graphene.

6. A radiation detection element comprising:
a detection layer which generates a charge by incidence of radiation; and
a pair of electrodes disposed on the detection layer,
wherein the detection layer has a metal halide layer,
wherein at least one of the pair of electrodes has a graphite surface, and
wherein the graphite surface and the metal halide layer are in contact with each other.

7. The radiation detection element according to claim 6, wherein the metal halide layer is a bismuth iodide layer.

8. The radiation detection element according to claim 6, wherein, in the metal halide layer, the metal halide is c-axis oriented.

9. The radiation detection element according to claim 6, wherein the metal halide layer is a layer formed by forming metal halide into a film on a graphite layer.

10. The radiation detection element according to claim 6,
wherein either one of the pair of electrodes has a surface containing graphite and the other electrode has a surface containing gold (Au), and
wherein a surface facing a contact surface with the surface containing graphite of the detection layer is in contact with the surface containing Au.

11. The radiation detection element according to claim 6, wherein the surface containing graphite is a surface containing graphene.

12. The radiation detection element according to claim 11, wherein the surface containing graphite is a graphite surface formed on a silicon carbide (SiC) substrate.

13. The radiation detection element according to claim 6, wherein either one of the pair of electrodes has a surface containing graphite and the other electrode is disposed on the detection layer through a layer.

14. A radiation detector comprising:
the radiation detection element according to claim 6; and
a signal processing unit electrically connected to the pair of electrodes.

15. A method for manufacturing a metal halide layer comprising forming metal halide into a film on a surface containing graphite.
